(19) United States
(12) Patent Application Publication
(10) Pub. No.: US 2005/0126225 A1
(43) Pub. Date: Jun. 16, 2005

(54) Tumbled, polished, vibrated broken tempered glass pieces

(76) Inventors: Edgar Edward Jaunzemis, Rancho Cucamonga, CA (US); Cladia Sue Jaunzemis, Rancho Cucamonga, CA (US)

Correspondence Address: Edgar E. Jaunzemis, 7438 Kirkwood Ave., Rancho Cucamonga, CA, 91730, US

(21) Appl. No.: 10/413,620

(22) Filed: Apr. 14, 2003

(51) Int. Cl. C03C 19/00; B24B 1/00

(52) U.S. Cl. 65/61; 65/114; 451/62

(57) ABSTRACT

A process and the product of tumbled and/or polished and/or vibrated broken tempered glass pieces produced by the means or the manufacture in doing the same to polish and remove the sharp edges from the broken tempered glass pieces. In a container which vibrates, and or rotates to achieve the produced product either by spinning vertically, horizontally or diagonally but not limiting to these motions, and or directions. The broken tempered glass is formed from fully tempered glass, heat strengthened glass and or toughened glass. This glass having a surface compression of at least 3,500 PSI to 10,000 PSI level. The glass being produced from molten silica based mix standard in the industry.

### FIELD OF INVENTION

The present invention relates to tumbled and/or polished and/or smoothed broken tempered glass pieces and more particularly to the suitability and handling of these once sharp, jagged and rough glass pieces for the use in but not limited to art, decoration, facade, stone work, lapidary, construction, paving, laminates, decorative, functional and nonfunctional uses and interior and exterior decorating.

### BACKGROUND OF INVENTION

Tumbling and/or polishing and/or vibrating are surface finishing operations of the broken tempered glass pieces are caused to move in a bed of treating elements, e.g., abrasive particles, aqueous matter, or against one another in such a manner that the relative motion between the tempered glass pieces and the treating of the elements cause an alteration of the surfaces, e.g., a polishing, de-burring, smoothing or material removed to create smooth glass pieces suitable for handling.

It has been proposed heretofore, to have improved upon the tumbled and/or polished and/or vibrated once sharp, jagged, rough tempered glass pieces by the means of simply tumbling and/or polishing and/or vibrating to create the smooth glass pieces suitable for handling.

This process of tumbling and/or polishing and/or vibrating is not very lengthy dependent upon the required results to be achieved. All three processes of the product vary in visual outcomes whether polished and/or tumbled, and/or vibrated—metallic surroundings, either ferrous or nonferrous containers, either in poly-based materials such as poly drums the results will vary dependent upon the method used to achieve the desired look of the polished and/or tumbled and/or vibrated tempered pieces.

### SUMMARY OF INVENTION

As mentioned, tumbling and/or polishing and/or vibrating of the tempered broken glass either in a horizontal, vertical or diagonal process with aqueous liquids with or without abrasives and or dry with or without abrasives is required to achieve tumbled and/or polished and/or vibrated broken tempered glass pieces that are now polished smooth, de-burred, and possible to handle for regardless the type of use has become a manageable and multifaceted use of the product.

In view of the fact that previously broken tempered glass has been discarded as waste. The object of this invention is to provide a newly processed and newly found product, which we found dozens of uses for, if not hundreds.

It is an object of the present invention to provide tumbled and/or polished and/or vibrated tempered glass pieces having an irregular smooth or polished surface pattern and or appearance. It is another object of the present invention to provide a method of producing tumbled and/or polished and/or broken tempered glass articles with an irregular, smooth polished surface pattern and or appearance.

The present invention is directed to tumbled and/or polished and/or vibrated tempered glass pieces consisting of tempered glass, heat-strengthened glass and or toughened glass that have been broken only to be tumbled and/or polished and/or vibrated to achieve the final product.

### BRIEF DESCRIPTION OF DRAWINGS

The object of the present invention, which is believed to be novel and set forth with particularity in the appended claims. The present invention in a manner of appearance showed to be of the simplest form.

FIG. 1 Computer black and white picture depicts tempered glass that has been broken, tumbled and/or polished and/or vibrated to achieve the end result. This picture is dated Jun. 13, 2003

FIG. 2 Computer black and white picture depicts a different type of tempered glass that has been broke, tumbled and/or polished and/or vibrated to achieve the end result. This picture is dated Jun. 13, 2003

### DETAILED DESCRIPTION OF THE PREFERRED EMBODIMENT

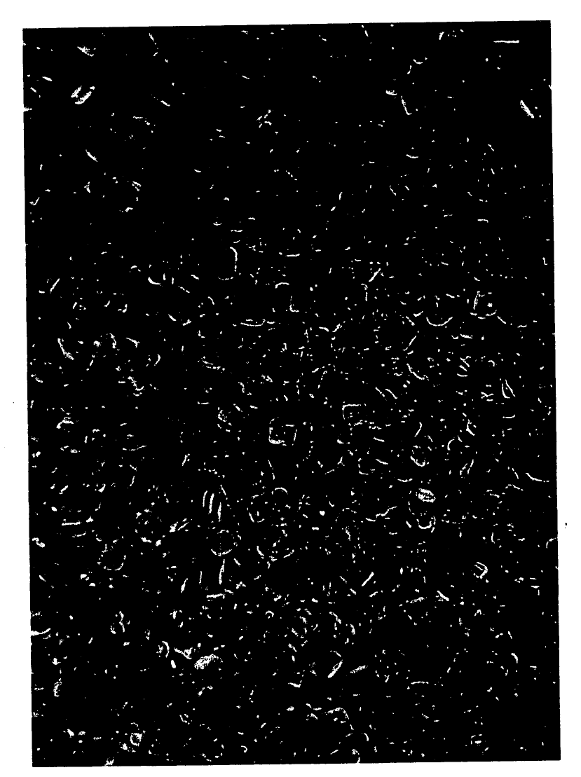

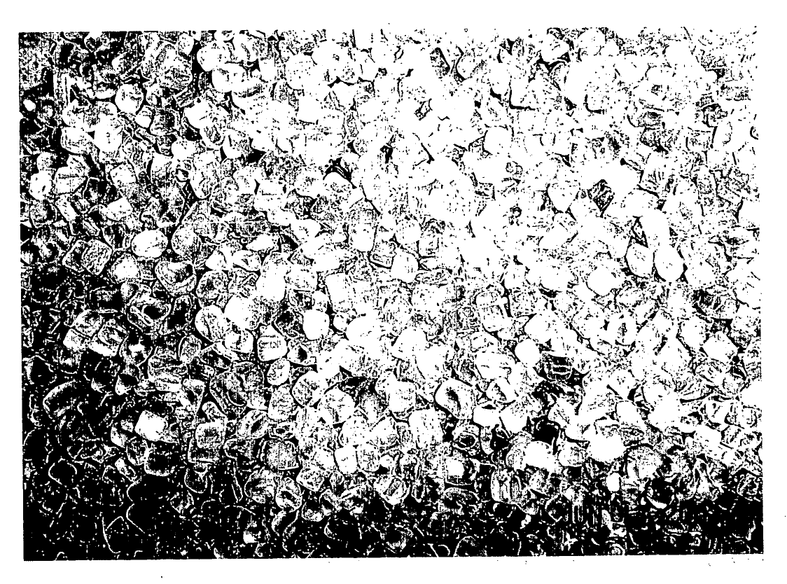

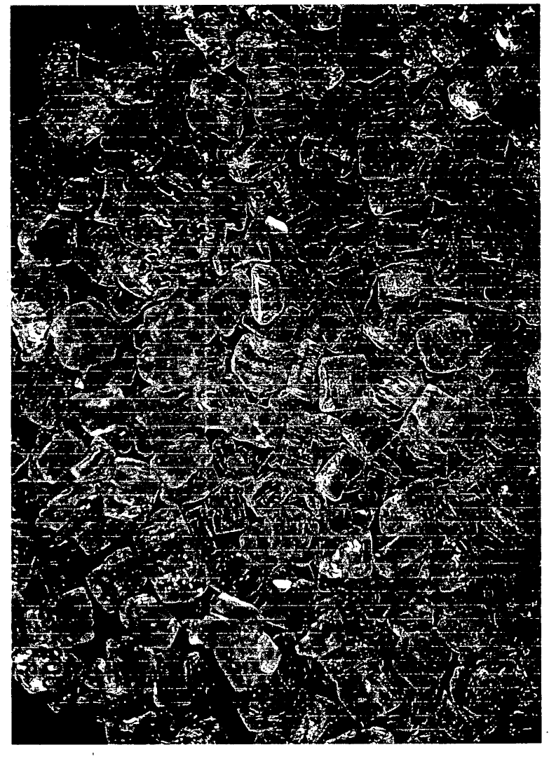

The tumbled and/or polished and/or vibrated broken tempered glass is relatively straight forward in form and shape or therefore the lack of as shown in FIGS. 1 and 2.

The principle features of the tumbled and/or polished and/or vibrated broken tempered glass pieces is purely novel and can be used functionally or non-functionally as an item for art, decoration, facade, stonework, lapidary, construction, paving laminates, decorative, interior and exterior decorating.

As described above the present invention provides for many facets in many industries although preferred embodiments of the present invention have been disclosed for illustrative purposes, those skilled in the art will appreciate the various modifications, additions and substitutions that are possible without departing from the scope and spirit of the invention as disclosed in accompanying claims.

The previous discussion describes in detail one embodiment of the invention and several variations of that embodiment. This discussion should not be construed, however, as limiting the invention to those particular embodiments as well.

The present invention contemplates a number of different variations of the above described preferred embodiment. It is to be understood that the description is only one of the preferred embodiments and scope of the invention is to be measured by the claim.

1. Broken tempered glass pieces having an irregular sharp and or rough edges and or surface pattern being tumbled and/or polished and/or vibrated to create smooth glass pieces suitable for handling.
A. These pieces being polished and/or tumbled and/or vibrated horizontally, vertically, or diagonally by using an abrasive medium, an aqueous medium or by tumbling dry and creating its own silica-based medium.
B. Tempered glass comprised of molten silica-based mix. This glass can be either tempered glass, heat-strengthened glass or also known as toughened glass. Having said tempering, strengthening, or toughening said glass this has created a surface compression of 3,500 PSI level and as much as 10,000 PSI level. The fracture characteristics of heat-strengthened glass vary widely from very much like annealed glass near the 3,500 PSI level to similar to fully tempered glass at the 10,000 PSI level.
C. The basic principle employed in the heat treating or tempering process is to create an initial condition of surface and edge compression. This condition is achieved by first heating the glass, then cooling the surfaces rapidly. This leaves the center glass thickness relatively hot compared to the surfaces. As the center thickness then cools, it forces the surfaces and edges into compression.
D. In the heat-treatment process the key procedure is application of a rapid air quench immediately upon withdrawal of hot (approximately 1,200 to 1,600 degrees F.) glass from the tempering furnace. The immediate and sustained application of an air quench produces the temper. As air direction against hot glass from arrays of fixed, reciprocation or rotating blast nozzles, it is important to extract heat uniformly from both surfaces.
E. Fully tempered glass has a unique fracture pattern. When fully tempered glass breaks the glass fractures into small, relatively harmless fragments. Sometimes jagged edges or sharp shards are included.
F. The method of tumbling and/or polishing and/or vibrating said tempered glass pieces to remove all if not most of the sharp edges, smooth the irregular edges if not all to create glass stone like pieces in irregular shapes not limited to size, shape or color.
G. Tumbling and/or polishing and/or vibrating of broken tempered glass pieces is not limited to the thickness of the tempered glass pieces nor the color.
H. Tumbling and/or polishing and/or vibrating of broken tempered glass pieces is not limited to the chemical make up of a molten silica base mix. As all broken tempered glass pieces can be tumbled, polished or vibrated.

2. Broken tempered glass pieces in claim 1 are not limited to size, thickness or color.

3. Broken tempered glass pieces in claim 1 are not limited to chemical make up which are suitable for tumbling and/or polishing and/or vibrating.

4. Methods for producing tumbled and/or polished and/or vibrated broken tempered glass:
A. Tumbling by rotation vertically, horizontally or diagonally
B. Polishing by rotation vertically, horizontally or diagonally
C. Vibrating by rotation vertically, horizontally or diagonally
D. By using aqueous methods otherwise known as liquids as a medium
E. By using a dry medium to achieve said polishing, smoothing and or de-burring

5. Tempered glass, heat-strengthened glass or toughened glass not limited to gas, electric or even microwave processes of these types of glass.
